(19) United States
(12) Patent Application Publication
(10) Pub. No.: US 2022/0230183 A1
(43) Pub. Date: Jul. 21, 2022

(54) SURGICAL CENTER MEDICAL INSTRUMENT REGULATING APPARATUS

(71) Applicants: Tamar Glaser, Palos Verdes, CA (US); Hannah Glaser, Palos Verdes, CA (US); Roberta Davis, Palos Verdes, CA (US)

(72) Inventors: Tamar Glaser, Palos Verdes, CA (US); Hannah Glaser, Palos Verdes, CA (US); Roberta Davis, Palos Verdes, CA (US)

(21) Appl. No.: 17/712,185

(22) Filed: Apr. 4, 2022

Related U.S. Application Data
(63) Continuation of application No. 16/163,447, filed on Oct. 17, 2018, now abandoned.

(51) Int. Cl. G06Q 30/00; G06K 7/14

(52) U.S. Cl. CPC G06Q 30/018; F24F 11/89; G06K 7/1413; G06K 7/1417

(57) ABSTRACT

The embodiments disclose an accreditation system with at least one accreditation database for storing accreditation standards and regulations, wherein the accreditation standards and regulations are updated on a predetermined basis, a computer server for analyzing and evaluating environmental conditions, equipment functionality and supplies availability of a facility of a registered company against the accreditation standards and regulations of the accreditation database on a predetermined basis to determine a compliance status by the registered company, wherein the server electronically reports the compliance status to the registered company on a predetermined basis and electronically monitors environmental conditions of equipment in the facility of the registered company using remote sensor devices coupled to the computer server on a predetermined basis.

### BACKGROUND

Advances in the health care industry have been accelerated over the past decades at ever increasing rates. Diagnostics, treatments, and medical procedures have become more specialized covering a wide range of health conditions. Health care services have expanded for the benefit of the patients. Accreditation of health care centers has provided patients and the health care insurers with oversight into the quality of care. The numbers and depth of compliance investigation of health care oversight agencies have equally expanded at the same accelerated rate as the advances in the health care industry. The business of the health care industry companies is faced with keeping pace with the accelerated rate of changes in order to maintain a compliant status with the oversight accreditation standards and regulations. Greater numbers of equipment, systems, services and facilities covering the wide range of medical specialties and the broadening of the accreditation standards and regulations to match those advances can no longer be handled by a cadre of administrators and staff alone.

### BRIEF DESCRIPTION OF THE DRAWINGS

FIG. 1 shows for illustrative purposes only an example of an overview of an accreditation compliance method and devices of one embodiment.

FIG. 2 shows for illustrative purposes only an example of a flow chart of a surgical company accreditation compliance method and devices of one embodiment.

FIG. 3 shows for illustrative purposes only an example of a flow chart of an ambulatory health care company accreditation compliance method and devices of one embodiment.

FIG. 4 shows for illustrative purposes only an example of an automatic accreditation standards and regulations updating process of one embodiment.

FIG. 5 shows for illustrative purposes only an example of an equipment compliance process of one embodiment.

FIG. 6 shows for illustrative purposes only an example of a process for determining compliance of one embodiment.

FIG. 7 shows for illustrative purposes only an example of accessing updated standards and regulations of one embodiment.

FIG. 8A shows for illustrative purposes only an example of displaying a web platform dashboard of one embodiment.

FIG. 8B shows for illustrative purposes only an example of a continuation of displaying a web platform dashboard of one embodiment.

FIG. 9 shows for illustrative purposes only an example of displaying user tasks of one embodiment.

FIG. 10 shows for illustrative purposes only an example of creating a user profile of one embodiment.

FIG. 11A shows for illustrative purposes only an example of a user input of facility details specialties of one embodiment.

FIG. 11B shows for illustrative purposes only an example of a user input of locations in a facility of one embodiment.

FIG. 12 shows for illustrative purposes only an example of a user input to identify equipment and locations of one embodiment.

FIG. 13 shows for illustrative purposes only an example of a user input to establish meetings and trainings of one embodiment.

FIG. 14 shows for illustrative purposes only an example of a display to manage periodic tasks of one embodiment.

FIG. 15 shows for illustrative purposes only an example of a process to correct and document out of compliance conditions of one embodiment.

### DETAILED DESCRIPTION OF THE INVENTION

In the following description, reference is made to the accompanying drawings, which form a part hereof, and in which is shown by way of illustration a specific example in which the invention may be practiced. It is to be understood that other embodiments may be utilized and structural changes may be made without departing from the scope of the embodiments.

### General Overview

It should be noted that the descriptions that follow, for example, in terms of accreditation compliance method and devices are described for illustrative purposes and the underlying system can apply to any number and multiple types of health care companies and facilities. In one embodiment of the present invention, the accreditation compliance method and devices can be configured using digital sensors. The accreditation compliance method and devices can be configured to include optical scanners and can be configured to include remote digital actuators using the embodiments.

The named invention herein is referred to as “accreditation compliance method and devices” and “AccredAbility” interchangeably without creating any limitation to an interpretation of the meanings disclosed herein. The abbreviation used herein “AAAHC” refers to the Accreditation Association for Ambulatory Health Care (AAAHC). The abbreviation used herein “AAAASF” refers to the American Association for Accreditation of Ambulatory Surgery Facilities (AAAASF).

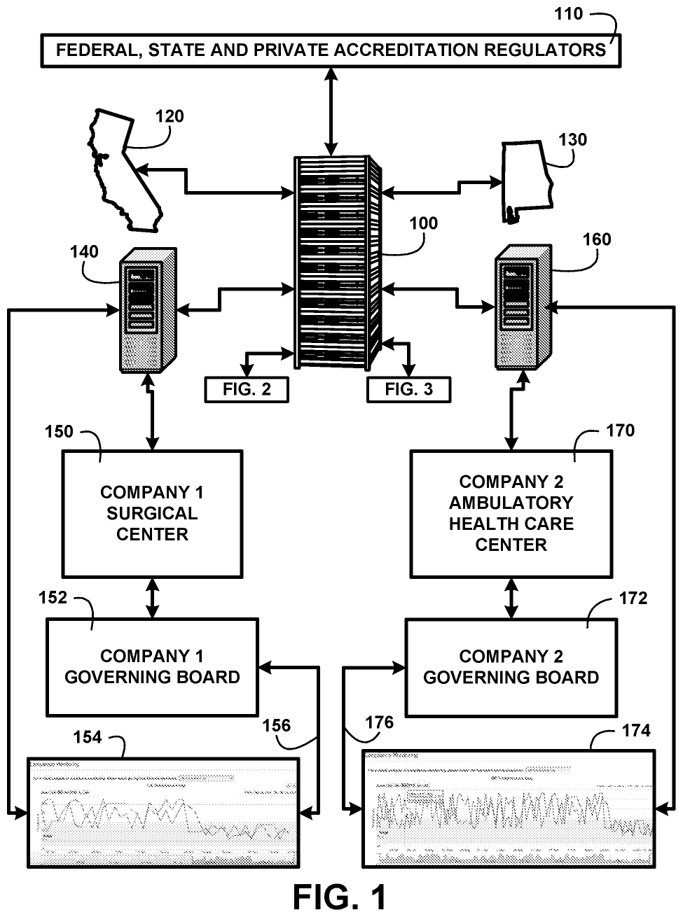

FIG. 1 shows for illustrative purposes only an example of an overview of an accreditation compliance method and devices of one embodiment. FIG. 1 shows an AccredAbility server 100 including WIFI connectivity, internet connectivity, digital processors, OCR devices, databases, printing devices, laser scanners, equipment interfaces, optical readers, and QR code and barcode readers. The AccredAbility server 100 data mines federal, state and private accreditation regulators 110 including Medicare, AAAHC, AAAASF, and state health care standards and regulations on a predetermined basis for changes, modifications and new issues to update the AccredAbility server 100 databases with those standards and regulations stored within. In one example a company, in this example referred to as Company 1, with at least one health care facility is located in California 120. Company 1 is registered on the AccredAbility server 100. Company 1 server 140 accreditation database is updated on a predetermined basis with the updated accreditation agencies and state of California standards and regulations downloaded automatically by the AccredAbility server 100. The updated accreditation standards and regulations are transmitted by the AccredAbility server 100 to a company 1 server 140 of a company 1 surgical center 150 and compliance activity is transmitted to the AccredAbility server 100.

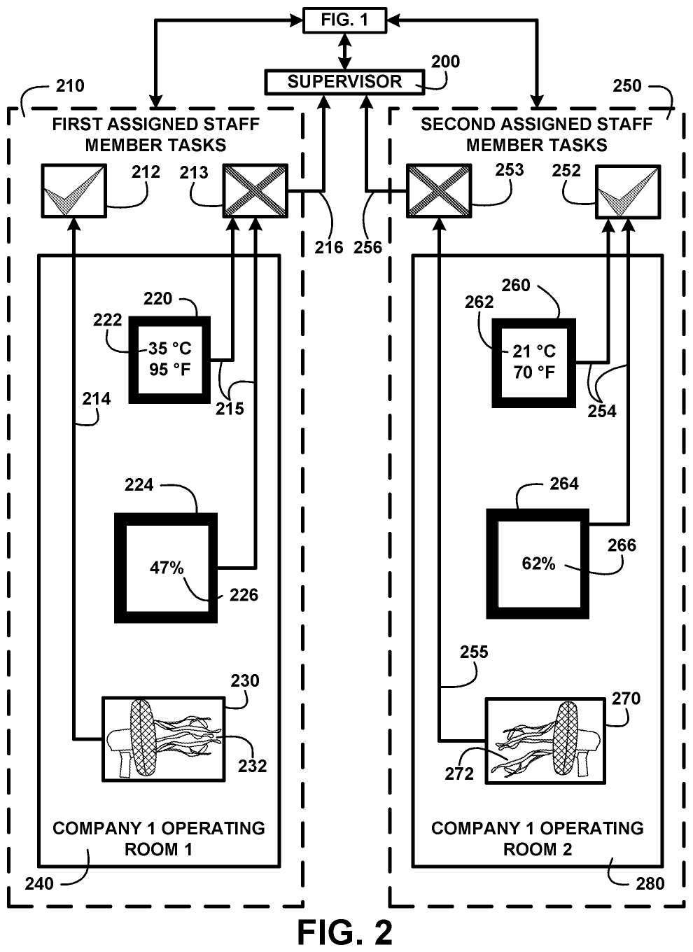

A company 1 accreditation compliance status report 154 shows graphically the progress of company 1 in reaching a fully compliant accreditation status before a planned accreditation inspection. The company 1 accreditation compliance status reporting to the governing board 156. Company 1 governing board 152 will use the company 1 accreditation compliance status report 154 for planning and management decision making for taking further actions. A company 1 accreditation compliance process overview is shown in FIG. 2 that illustrates an example of the interactivity of the AccredAbility server 100 with the company 1 server 140 and equipment used in the company 1 surgical center 150 of one embodiment.

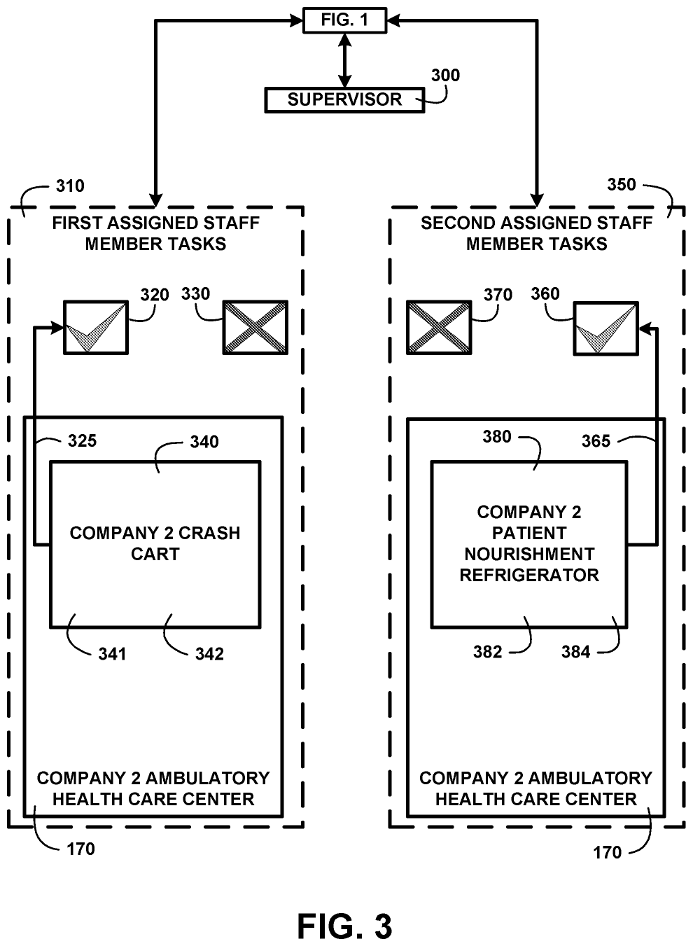

In another example State 2 130 for example Alabama is the location of a company 2 server 160 in a company 2 ambulatory health care center 170. Company 2 is registered with the AccredAbility server 100. A company 2 governing board 172 can review a current status of a company 2 accreditation compliance status report 174 by logging into a Company 2 server 160. Periodically company 2 accreditation compliance status reporting is transmitted to the company 2 governing board 176. The company 2 accreditation compliance status report 174 shows graphically the company 2 accreditation compliance status to enable the company 2 governing board 172 to take any actions they feel are needed to obtain full compliance. In this example company 2 is in a full compliance status prior to the scheduled accreditation inspections. A company 2 accreditation compliance process overview is shown in FIG. 3 that illustrates an example of the interactivity of the AccredAbility server 100 with the company 2 server 160 and equipment used in the company 2 ambulatory health care center 170 of one embodiment.

The accreditation compliance method and devices provides users with a method of inputting a Profile to create a custom profile for a health care facility including for example a surgery center with number of ORs, type of specialties, Medicare participation, and accreditation agencies applicable to the health care facility including AAASF, AAASC, and Joint Commission and automatically updates accreditation compliance standards and regulations. The accreditation compliance method and devices capture all information and data for accreditation for replacing binders and clipboards with user digital devices including tablets, smart phones, computers and laptop computers and other internet enabled devices. It facilitates monitoring of accreditation standards and preparing all required tests captured quickly and accurately.

The accreditation compliance method and devices perform analysis of equipment, devices, physical conditions of facility locations, and supply adequacy on a predetermined basis for recognizing any value out of compliance and/or any missing data elements and alerts the user immediately. No more missing information or incomplete reports. The user accreditation reports are set for compliance with the standards and regulations for the user facility. The accreditation compliance method and devices perform prepares reports using the data elements recorded and tracked by date and are available 24/7 from the user secure website. Where appropriate, reports are sent directly to a Governing Board for immediate review and approval—further ensuring the compliance process. The accreditation compliance method and devices facilitate inspections by accreditation agencies ensuring a user is always ready and always prepared for any inspection. The accreditation inspector can simply log onto the user account and have instant access to all reports and data. The accreditation compliance method and devices have the capability to connect with the outside agencies including AAAHC, AAAASF, Medicare, and others. In this manner these agencies can monitor the facilities compliance directly of one embodiment.

### DETAILED DESCRIPTION

FIG. 2 shows for illustrative purposes only an example of a flow chart of a surgical company accreditation compliance method and devices of one embodiment. FIG. 2 shows a continuation from FIG. 1. Assigned staff tasks include daily monitoring of for example operating room compliant environmental conditions. The updated accreditation data shows normal operating room compliant environmental conditions include a temperature in a range of 18 to 23 CC, humidity in a range of 50 to 60%, and air changes of 20 per hour. Assigned staff tasks include for example monitoring various equipment normal operating conditions. A first assigned staff member tasks 210 of company 1 is tasked with monitoring of operating room 1 240.

Operating room 1 240 includes for example a wireless digital temperature sensor 1 220, a wireless digital humidity sensor 1 224 and a wireless digital air flow sensor 1 230 to determine the environmental conditions.

A wireless digital temperature sensor includes a wireless digital actuator including a thermostat temperature setting device not shown for adjusting heating and cooling equipment devices compliant temperature settings. A wireless digital humidity sensor includes a wireless digital actuator including a wireless digital dehumidifier device humidity level setting actuator for lowering the OR humidity and a wireless digital vaporizer device humidity level setting actuator for raising the OR humidity.

A wireless digital air flow sensor includes an air handler actuator RPM setting device for adjusting the RPM of an air handler to raise an air flow rate by increasing the RPM and decreasing an air flow rate by lowering the air handler RPM using for example an air handler fan motor rheostat. The wireless digital actuators can be operated remotely using an AccredAbility application installed on a digital device. The wireless digital actuators can be operated remotely by the AccredAbility server 100 of FIG. 1 when a non-compliant reading is recorded from the wireless digital sensors coupled to the wireless digital actuators wherein the AccredAbility server 100 of FIG. 1 digital processor calculated value of a non-compliant sensor reading is out of the range of acceptable compliance values. The wireless digital actuators are activated until the non-compliant resulting activated setting reading of the conditions is within the acceptable compliance values.

The wireless digital temperature sensor 1 220 has transmitted a temperature 35° C. 222 showing above an acceptable compliance temperature level. The wireless digital temperature sensor 1 220 sends via WIFI email an alert to the first assigned staff member and to the first assigned staff member supervisor 200. The wireless digital humidity sensor 1 224 has transmitted a humidity reading of 47% 226 showing below an acceptable compliant humidity level.

The wireless digital air flow sensor 1 230 illustrates an air flow reading that is in compliance with an acceptable air flow rate. Air flow sensor 1 compliant data 232 is suffixed as compliant 214 and transmitted 212 to the company 1 server 140 of FIG. 1 where that data is recorded and the first assigned staff member tasks 210 of company 1 is indicated as complete. The non-compliant data 215 from wireless digital temperature sensor 1 220 and wireless digital humidity sensor 1 224 is suffixed as non-compliant. The non-compliant data 215 triggers an alert 213 to the first assigned staff member 210 and a non-compliant data alert is also sent to the supervisor 200 for corrective action 216 of one embodiment.

A second assigned staff member tasks 250 of company 1 is tasked with monitoring of operating room 2 280. Operating room 2 includes a wireless digital temperature sensor 2 260, a wireless digital humidity sensor 2 264, and a wireless digital air flow sensor 2 270. The wireless digital temperature sensor 2 260 is registering 21° C. 262 within the compliant acceptable range. The wireless digital humidity sensor 2 264 is registering 62% 266 humidity within the compliant acceptable range. The compliant data 254 is suffixed for compliance and transmitted 252 to the company 1 server 140 of FIG. 1 for recording and the second assigned staff member tasks 250 is indicated as complete.

The wireless digital air flow sensor 2 270 shows an air flow rate 272 below the acceptable compliant air flow and is suffixed as non-compliant. The non-compliant data 255 triggers an alert 253 to the first assigned staff member 250 and a non-compliant data alert is also sent to the supervisor for corrective action 256 of one embodiment.

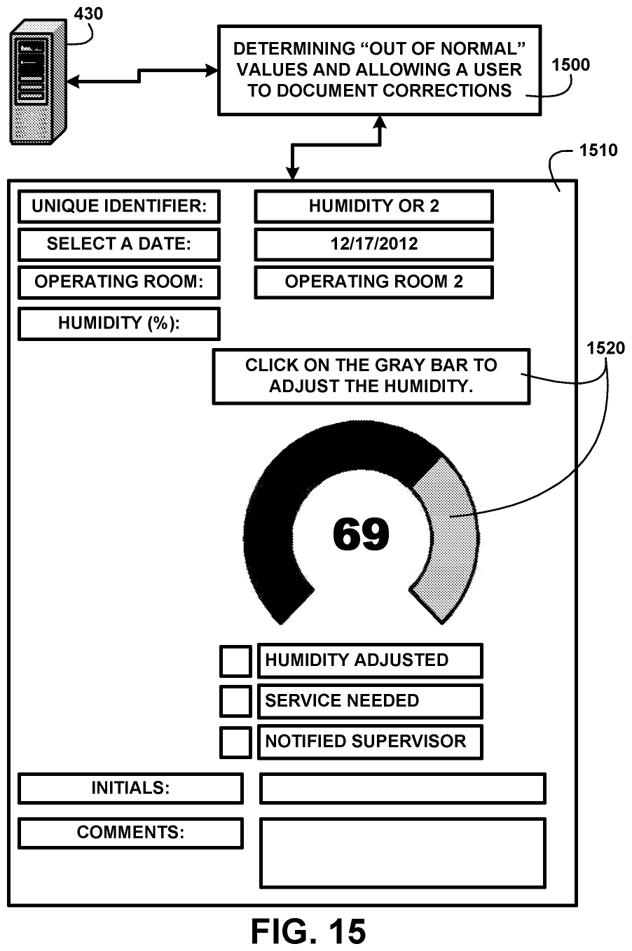

The wireless digital sensors include a digital actuator for adjusting the operating level of the equipment they are coupled with allowing a supervisor to remotely adjust the operating level to correct a non-compliant condition. As shown in FIG. 15 the supervisor 200 corrective action is accomplished using an AccredAbility application installed on a digital device including a smart phone. When the supervisor 200 takes this correction action it is recorded in the Company 1 server 140 of FIG. 1 for documentation.

The assigned staff members' tasks are then appended to include a daily check to evaluate whether the corrective operating level adjustment brings the non-compliant condition into compliance. If the non-compliant condition does not become compliant then the supervisor 200 is again alerted and based on suggested alternative corrective actions generated by the AccredAbility server 100 of FIG. 1 may order maintenance on the offending equipment of one embodiment.

In another embodiment the control of temperature, humidity and air flow throughout a health care facility can include nested control devices and smart devices including nest thermostats, nested temperature sensors, smart humidifiers, smart dehumidifiers, smart air flow fan speed regulators and smart refrigeration units installed in sectionalized zones of the health care facility. For example the nested thermostats and temperature sensors can begin cooling the temperature in one zone that is experiencing a rise in temperature due to heavy use. Another set of nested thermostats and temperature sensors in a different zone that has been unused for a period of time has maintained compliance temperatures and no heating or cooling is used. Nested and smart devices can assist in reducing energy consumption versus centralized control of temperature, humidity and air flow throughout an entire health care facility. It further provides an assist to reduce or prevent any human errors that may occur in monitoring the environmental conditions that could increase a migration in and out of compliance standards.

### An Ambulatory Health Care Company Accreditation Compliance Method and Devices:

FIG. 3 shows for illustrative purposes only an example of a flow chart of an ambulatory health care company accreditation compliance method and devices of one embodiment. FIG. 3 shows a continuation from FIG. 1 including a first assigned staff member tasks 310 for a company 2 ambulatory health care center 170 monitoring of a crash cart 340 compliance. The crash cart 340 is at a crash cart docking location including for example a wireless digital defibrillator charging sensor 341 and wireless digital defibrillator battery charge sensor 342 not shown. The wireless digital defibrillator charging sensor 341 and wireless digital defibrillator battery charge sensor 342 provide remote monitoring of the crash cart 340 defibrillator to assure it is fully charged when needed recording the sensor reading with the company 2 server 160 of FIG. 1.

Crash cart supplies are coupled with a QR code and barcode labels. The first assigned staff member using a digital device with the AccredAbility application installed including a smart phone can capture a photo image of the crash cart supplies. The captured photo image is transmitted to the company 2 server 160 of FIG. 1 and scanned by an optical reader of the AccredAbility server 100 and the QR and barcode labels are read using the QR code and barcode readers to identify the supplies and track the number of each type.

If the defibrillator charge is below full and/or the inventory of the crash cart supplies is deficient from the predetermined quantities and types that would be crash cart non-compliant data 330 then an alert would be transmitted with a WIFI email to the first assigned staff member and company 2 supervisor 300. The wireless digital defibrillator charging sensor and wireless digital defibrillator battery charge sensor recorded operating data can show if the power to the crash cart docking location is on or off indicating an electrical problem. The company 2 supervisor 300 can them issue a maintenance work order to check and correct the problem. The maintenance crew can also check whether the defibrillator rechargeable battery is faulty and replace it. The corrective actions taken are recorded in the company 2 server 160 of FIG. 1.

In this example the wireless digital defibrillator charging sensor and wireless digital defibrillator battery charge sensor show the defibrillator is fully charges and compliant with the accreditation standards and regulations. The crash cart 340 supply inventory scan shows the crash cart 340 supplies are fully stocked and in compliance. Crash cart compliant data 325 is transmitted to the company 2 server 320 and the company 2 first assigned staff member tasks 310 is indicated to be complete.

A second assigned staff member tasks 350 of the company 2 ambulatory health care center 170 includes monitoring of a patient nourishment refrigerator 380. A patient nourishment refrigerator wireless digital temperature sensor 382 not shown reports the current temperature of the patient nourishment refrigerator 380. A temperature reading by the patient nourishment refrigerator wireless digital temperature sensor 382 shows the temperature of the patient nourishment refrigerator 380 is within compliance with the accreditation temperature standards. Patient nourishment refrigerator supplies 384 not shown are coupled with QR code and barcode labels can be inventoried by the second assigned staff member using a digital device with the AccredAbility application installed. The inventory can include using a digital device smart phone to capture a photo image of the patient nourishment refrigerator supplies 384.

The captured photo image is transmitted to the company 2 server 160 of FIG. 1 and scanned by an optical reader of the AccredAbility server 100 of FIG. 1 and the QR and barcode labels are read using the QR code and barcode readers to identify the supplies and track the number of each type. In this example the QR and barcode labels reading inventory results show the patient nourishment refrigerator supplies 384 are fully stocked and compliant with the accreditation standards.

In this example both the temperature and supply inventory of the patient nourishment refrigerator 380 form patient nourishment refrigerator compliant data 365 that is transmitted to company 2 server 360 for recording and suffixed as in accreditation compliance. The second assigned staff member tasks 350 are indicated as complete. No patient nourishment refrigerator non-compliant data 370 has been determined and so no patient nourishment refrigerator non-compliant data 370 alerts have been sent to the second assigned staff member and company 2 supervisor 300 of one embodiment.

The AccredAbility server 100 of FIG. 1 creates QR code and barcode label data from the profile inputted data of an AccredAbility registered company. The profile inputted data includes locations (areas) within a registered company center, for example a nurses station (pre-op/recovery), equipment storage and medication room to name a few. The profile inputted data includes equipment including for example a no. of patient nourishment refrigerators, no. of sterilizers, no. of fire extinguishers, and no. of crash carts. An example of a few crash cart supplies and equipment includes equipment and supplies including Airway (oral and nasal) all sizes, Non rebreather oxygen face masks (3 sizes), IV start packs, Normal saline solution (1000 ml bags), Gauze, Alcohol preps, and Monitor with defibrillator (preferred) or AED and Drugs including Aspirin 81 mg Tablets, Nitroglycerin spray or 0.4 mg tablets, Epinephrine 1:10,000 Abboject™ (3), EpiPen® (2), and Benadryl 50 mg vial (2) of one embodiment.

Examples of what a QR code and barcode labels can be coupled is a Monitor with defibrillator (preferred) or AED, the crash cart carriage with wheels, and a package of multiple individually packaged gauze pads. The AccredAbility server 100 of FIG. 1 assigns a unique number to each piece of equipment and supplies inputted by a registered company and the applicable accreditation standard and regulations that is formatted for printing on self-adhesive labels. In the case of for example the package of multiple individually packaged gauze pads one label is created for the multi-pack and individual labels for the individually packaged gauze pads. When for example an assigned staff member performs a supply inventory, one label for a multi-pack defines the name, use and number of the individual pack inside. When the multi-pack is opened the assigned staff member can couple the individual pack with the individual label. The periodic inventory may be performed daily. The results of the starting and ending inventory provides quantity use patterns that can be used in projecting reorders and for billing for patients for whom the supplies were consumed of one embodiment.

QR code and barcode labels can be printed by the registered company in house. QR code and barcode labels can be printed using the AccredAbility server 100 of FIG. 1 and mailed to the registered company. This may provide a confirmation of the inputted equipment wherein if the registered company finds they do not have enough labels for all the equipment then the inputted equipment listings was deficit and this would identify the equipment missing from the inputted equipment listings and provide a basis for updating the equipment listing. This serves to prevent an accreditation difficulty if the non-listed equipment is not accounted for in the accreditation processing. It further ensures all equipment being used meets the accreditation standards and regulations prior to an inspection of one embodiment.

### An Automatic Accreditation Standards and Regulations Updating Process:

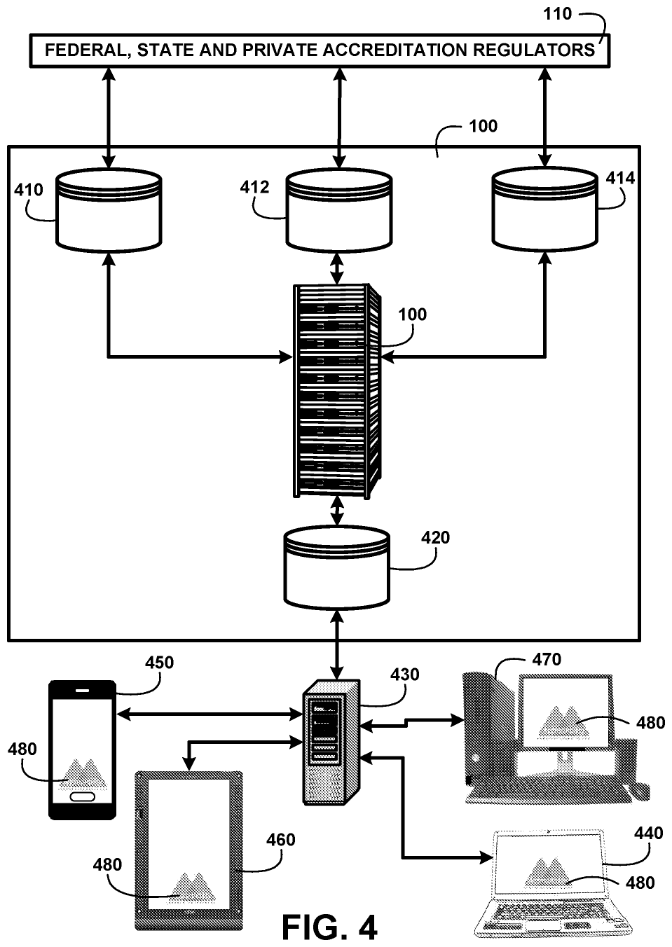

FIG. 4 shows for illustrative purposes only an example of an automatic accreditation standards and regulations updating process of one embodiment. FIG. 4 shows the AccredAbility server 100 downloading from federal, state and private accreditation regulators 110 changes, modifications and new issues to update a federal accreditation database 410, a state accreditation database 412, and private accreditation database 414. The AccredAbility server 100 populates at least one updated accreditation standards and regulations database 420 with specific accreditation standards and regulations applicable to a registered company profile. The populated specific accreditation standards and regulations are downloaded to a registered company server 430. The registered company staff can remotely access functions of the registered company server 430 using the AccredAbility application 480 installed on a digital device including a smart phone 450, a tablet 460, a computer 470 and a laptop computer 440 of one embodiment.

### An Equipment Compliance Process:

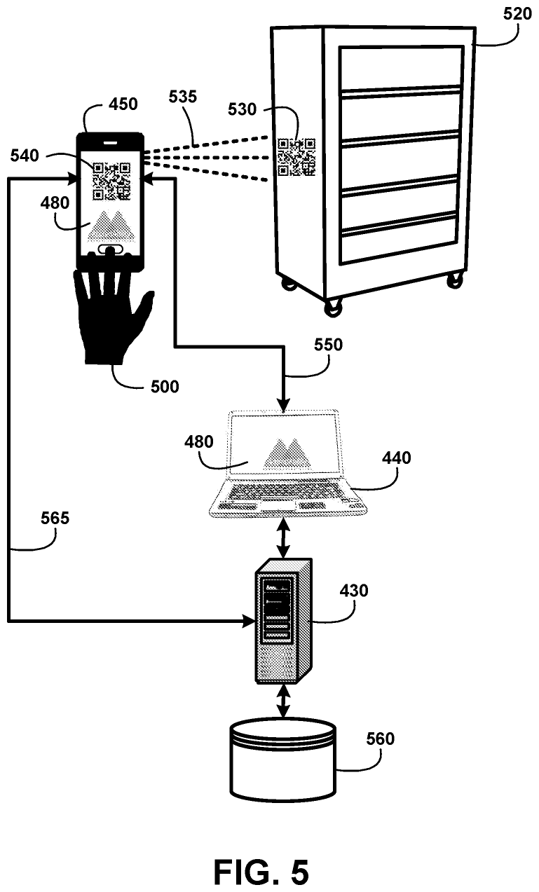

FIG. 5 shows for illustrative purposes only an example of an equipment compliance process of one embodiment. FIG. 5 shows a user 500 activating a camera of the smart phone 450 with the AccredAbility application 480. The user 500 is using the smart phone camera to take a photo of a QR code 535 coupled to a registered company piece of equipment 520 for example a medication refrigerator. The registered company piece of equipment 520 is identified with a coupled QR code 530. Upon capturing a QR code image 540, the QR code image 540 is transmitted over WIFI to a laptop computer 550. The laptop computer 440 with the AccredAbility application 480 is used to transmit the QR code image to the registered company server 430 as part of an equipment compliance process and recorded in a registered company equipment database 560. The QR code image 540 may be transmitted to the registered company server directly 565. In a compliance process the registered company server 430 records the QR code image 540 and coded data on the registered company equipment database 560 as part of an equipment compliance process including an equipment inventory of one embodiment.

### A Process of Determining Compliance:

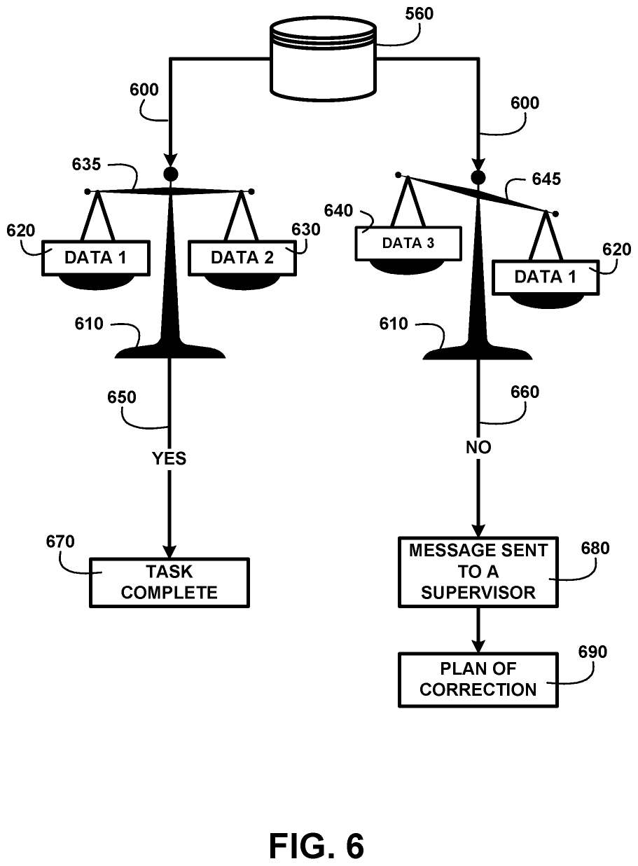

FIG. 6 shows for illustrative purposes only an example of a process for determining compliance of one embodiment. FIG. 6 shows the registered company equipment database 560 using for example a QR code identified piece of equipment operational log of recorded accreditation compliance data 600 for performing an analytical evaluation process 610 on the AccredAbility server 100 of FIG. 1. A scale is shown as an illustrative representation only of the analytical evaluation process 610 for determining an accreditation compliance status of the QR code identified piece of equipment. Data 1 620 is the accreditation compliance from the updated standards and regulations applicable for the QR code identified piece of equipment. Data 2 630 for example is one set of recorded accreditation compliance data for an operational period of time for the QR code identified piece of equipment. Data 2 is evaluated against data 1 635. The data 2 630 analytical determination results in a positive finding of yes 650 for that period of time the identified piece of equipment is accreditation compliant 650. The accreditation compliant result is recorded and a compliance task complete indication is recorded 670.

Data 3 640 is another set of recorded accreditation compliance data for an operational period of time for the QR code identified piece of equipment. Data 3 is evaluated against data 1 645. The data 3 640 analytical determination results in a negative finding of no 650 for that period of time the identified piece of equipment is accreditation non-compliant 660. The negative finding triggers an alert message sent to a supervisor 680 wherein the supervisor determines a plan of correction 690 of one embodiment.

### Accessing Updated Standards and Regulations:

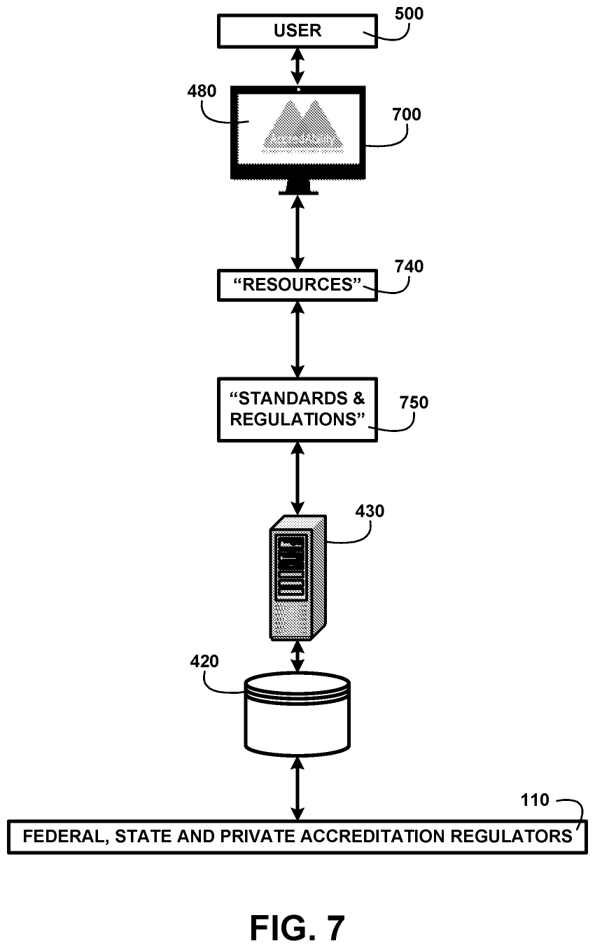

FIG. 7 shows for illustrative purposes only an example of accessing updated standards and regulations of one embodiment. FIG. 7 shows the user 500 for example a member of a company governing board using a digital device for example a computer 700 and the AccredAbility application 480 for accessing updated standards and regulations. The user can click on a “resources” 740 tab on the main menu then click on a “standards and regulations” 750 tab. The AccredAbility application website platform will then connect to the registered company server 430. The registered company server 430 will direct the user to their company updated standards and regulations database 420. The updated standards and regulations database 420 will display on the computer screen federal, state and private accreditation regulators 110 updated standards and regulations. This process allows users to access accreditation compliance guidelines all in one place with ease.

### Displaying a Web Platform Dashboard:

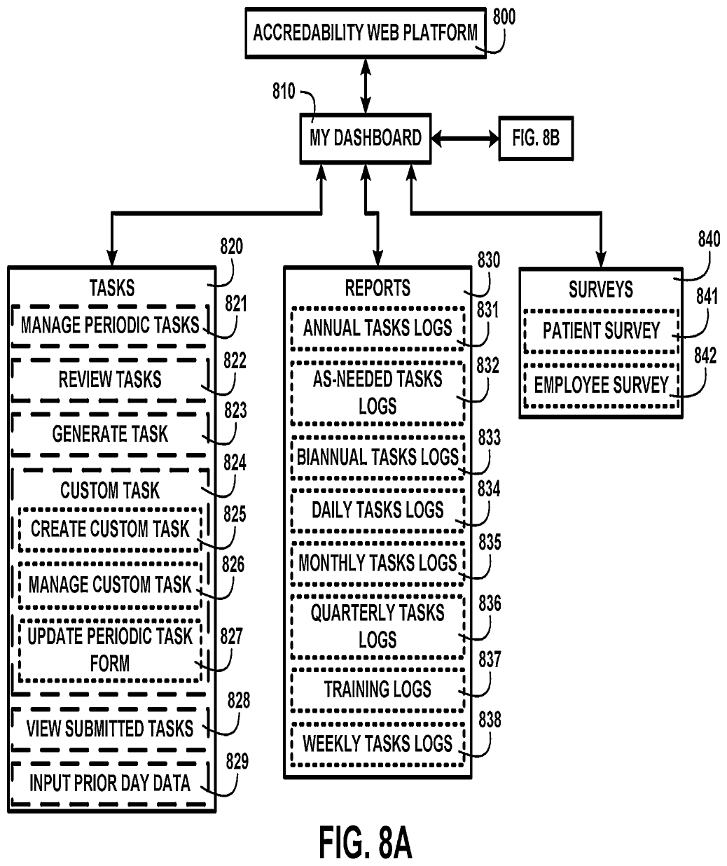

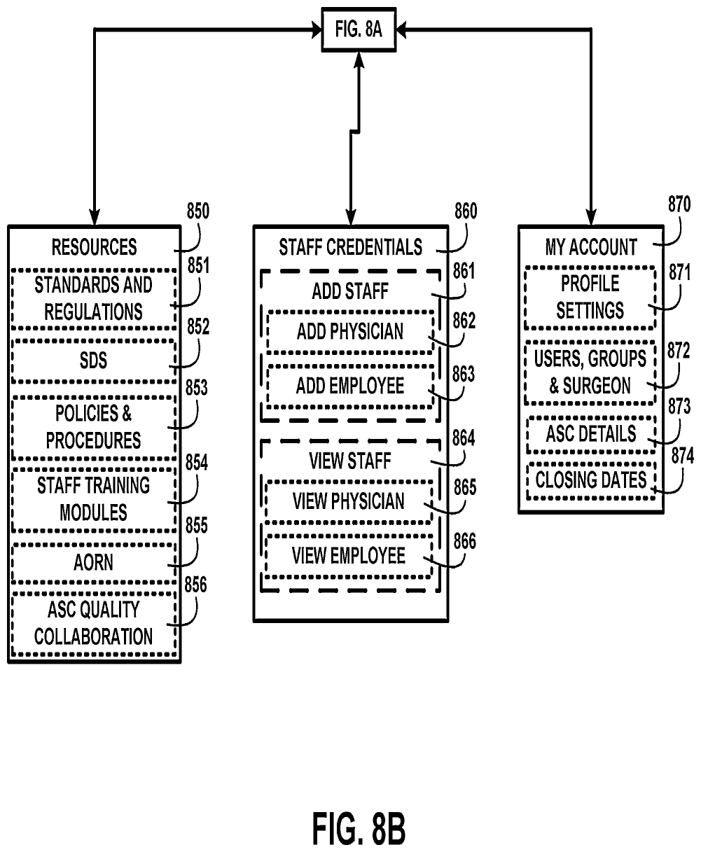

FIG. 8A shows for illustrative purposes only an example of displaying a web platform dashboard of one embodiment. FIG. 8A shows an AccredAbility web platform 800 displaying on a computer screen, not shown, a my dashboard 810 web page. The my dashboard 810 shows a user selection of tabs that can be clicked by the user to select an area of interest. In this example one area of interest may be tasks 820. Upon clicking the tasks 820 tab multiple selections are displayed from which the user can make a subsequent selection. Tasks 820 subsequent selections include for example manage periodic tasks 821, review tasks 822, generate task 823, custom task 824, create custom task 825, manage custom task 826, update periodic task form 827, view submitted tasks 828, and input prior day data 829.

Another tab is reports 830 which includes for example annual tasks logs 831, as-needed tasks logs 832, biannual tasks logs 833, daily tasks logs 834, monthly tasks logs 835, quarterly tasks logs 836, training logs 837, and weekly tasks logs 838.

A third tab is for selecting surveys 840. Surveys 840 include for example patient survey 841 and employee survey 842. The my dashboard 810 web page is further described in FIG. 8B.

### A Continuation of Displaying a Web Platform Dashboard:

FIG. 8B shows for illustrative purposes only an example of a continuation of displaying a web platform dashboard of one embodiment. FIG. 8B shows continuing from FIG. 8A additional my dashboard 810 of FIG. 8A web page selections including resources 850 that includes standards and regulations 851, SDS 852, policies & procedures 853, staff training modules 854, aorn 855, and ASC quality collaboration 856. Another tab is staff credentials 860 including add staff 861, to further select add physician 862 and add employee 863. A view staff 864 tab includes view physician 865 and view employee 866 selections.

A final my dashboard 810 of FIG. 8A web page selection in this example is my account 870. My account 870 when clicked provides selections including profile settings 871, users, groups & surgeon 872, ASC details 873, and closing dates 874 of one embodiment.

### Displaying User Tasks:

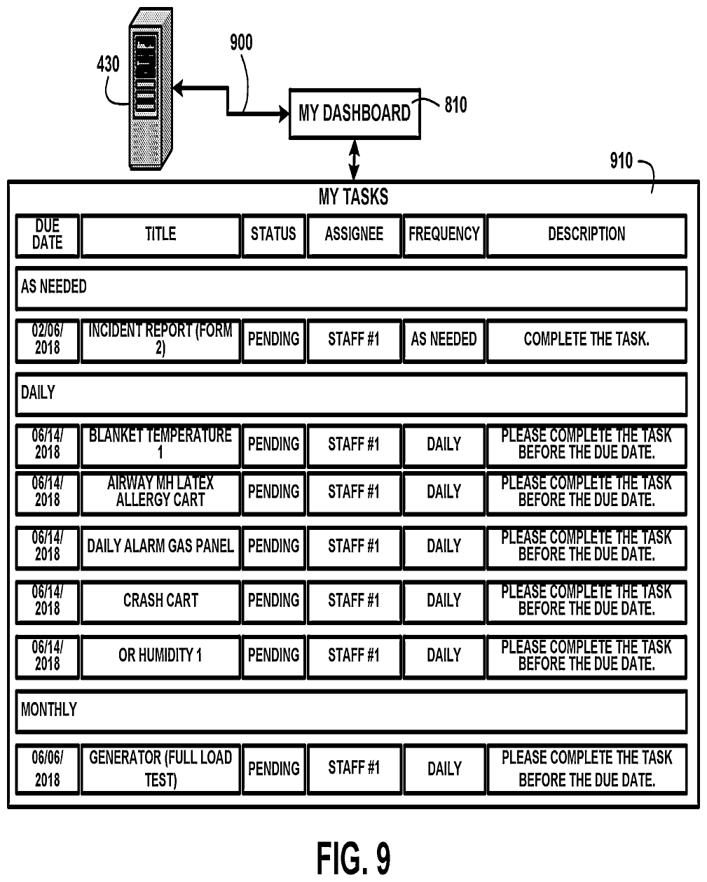

FIG. 9 shows for illustrative purposes only an example of displaying user tasks of one embodiment. FIG. 9 shows the registered company server 430 displaying on a computer screen 900, not shown, the my dashboard 810 web page with a my tasks 910 listing for a user daily tasks 912. The users' daily tasks 912 include a due date, title, status, assignee, frequency, and description. The user can setup the AccredAbility application 480 of FIG. 4 to automatically open and display daily the my dashboard 810 web page with a my tasks 910 listing for user daily tasks 912 when the user starts their digital device of one embodiment.

### Creating a User Profile:

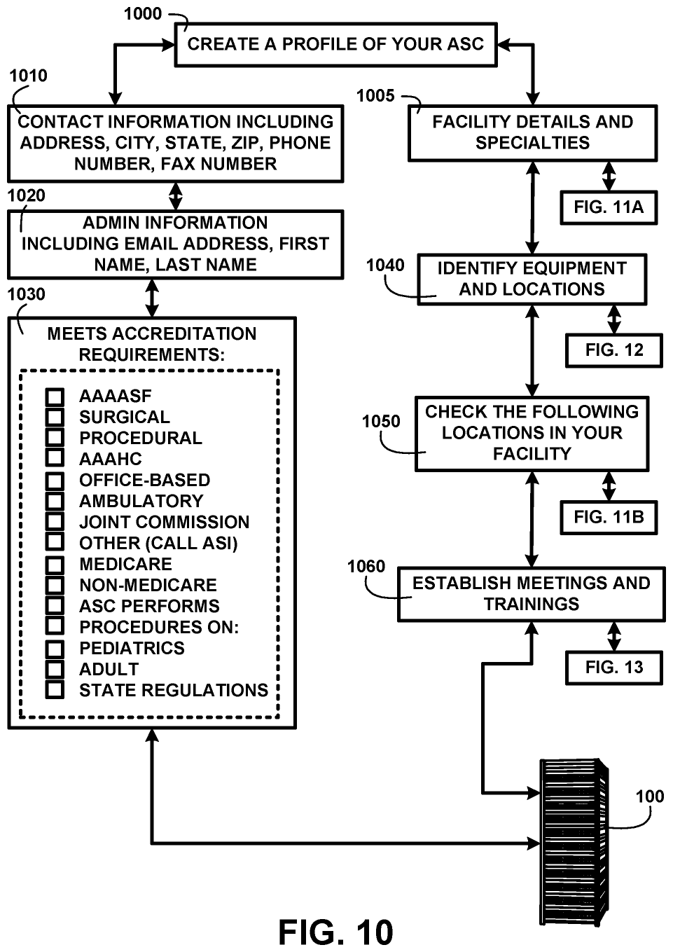

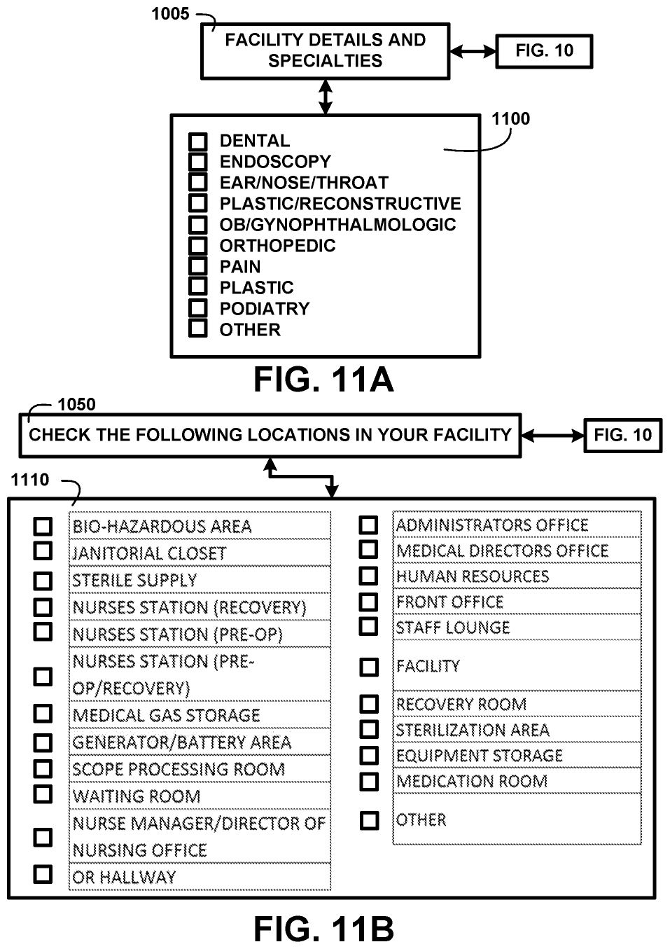

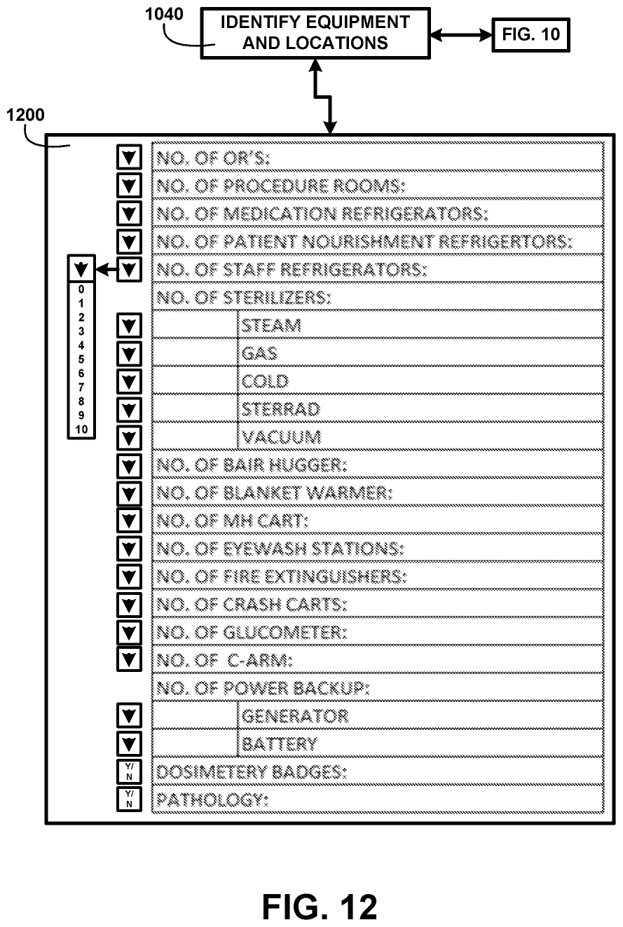

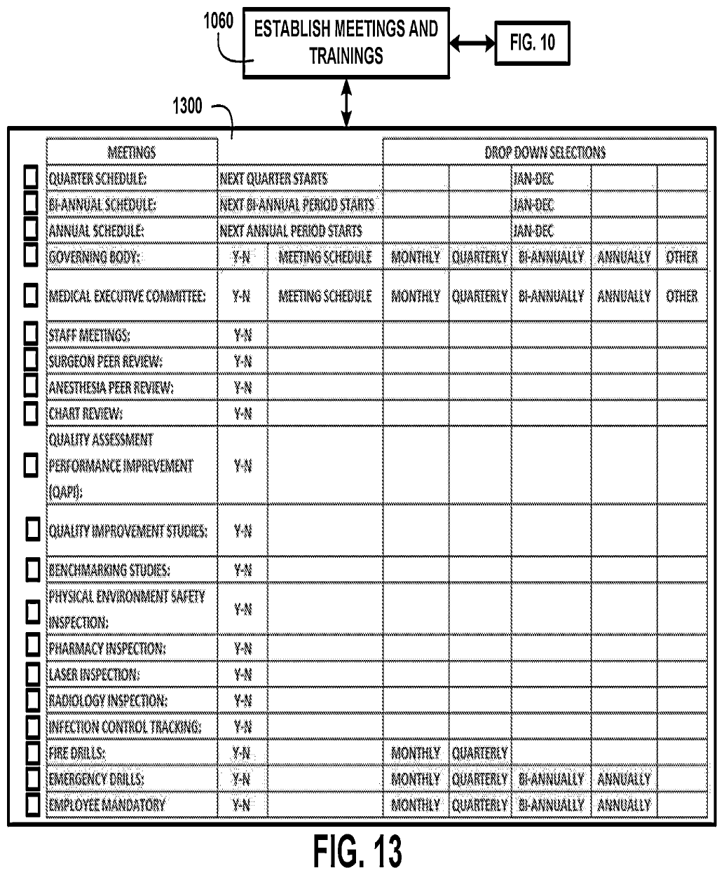

FIG. 10 shows for illustrative purposes only an example of creating a user profile of one embodiment. FIG. 10 shows an AccredAbility application 480 of FIG. 4 web page on a computer screen not shown to create a profile of your ASC 1000. The profile will include for example contact information including address, city, state, zip, and phone number, and fax number 1010, admin information including email address, first name, and last name 1020. The profile also include a check list for the company which meets accreditation requirements: 1030 wherein a user checks a box next to all applicable accreditation agencies and types associated with their company. The information is uploaded and recorded on the AccredAbility server 100. A user continues to input company information including facility details and specialties 1005 on FIG. 11a, identify equipment and locations 1040 on FIG. 12, check the following locations in your facility 1050 on FIG. 11b and establish meetings and trainings 1060 on FIG. 13 of one embodiment.

### A User Input of Facility Details Specialties:

FIG. 11A shows for illustrative purposes only an example of a user input of facility details specialties of one embodiment. FIG. 11A shows a continuation from FIG. 10 where the user continues inputting company information including facility details and specialties 1005 including medical and health care specialties wherein the user checks the box next to an applicable specialty 1100. The applicable specialty 1100 includes for example plastic/reconstructive. The checked boxes information is uploaded and recorded on the AccredAbility server 100 of FIG. 1 as shown in FIG. 10 of one embodiment.

### A User Input of Locations in a Facility:

FIG. 11B shows for illustrative purposes only an example of a user input of locations in a facility of one embodiment. FIG. 11B shows from FIG. 10 the user continuing inputting company information including check the following locations in your facility 1050. The user checks the box next to applicable types of location descriptions 1110 for example nurses station (pre-op). The checked boxes information is uploaded and recorded on the AccredAbility server 100 of FIG. 1 as shown in FIG. 10 of one embodiment.

### A User Input to Identify Equipment and Locations:

FIG. 12 shows for illustrative purposes only an example of a user input to identify equipment and locations of one embodiment. FIG. 12 shows a continuation from FIG. 10 where the user continues inputting company information including identify equipment and locations 1040. The user clicks on a drop down icon and selects the number of the particular equipment description to show how many pieces of that equipment are located in the facility 1200. A particular equipment description includes for example a no. of staff refrigerators. Some types of equipment have a drop down icon that displays when clicked a yes or no (y/n) selection to indicate whether for example the facility includes a pathology lab. The checked boxes information is uploaded and recorded on the AccredAbility server 100 of FIG. 1 as shown in FIG. 10 of one embodiment.

### A User Input to Establish Meetings and Trainings:

FIG. 13 shows for illustrative purposes only an example of a user input to establish meetings and trainings of one embodiment. FIG. 13 shows a user continuing to input company information from FIG. 10. The additional company information includes information to establish meetings and trainings 1060. A check list of types of meetings and trainings are displayed on a user computer screen 1300 not shown. The user checks a box next to a selected meeting description then using a drop down selector selects for example a month or meeting schedule frequency for the checked selected meeting. Some meetings only offer a yes or no (y-n) selection to indicate that type of described meeting is held or not. The checked boxes information is uploaded and recorded on the AccredAbility server 100 of FIG. 1 as shown in FIG. 10 of one embodiment.

### A Display to Manage Periodic Tasks:

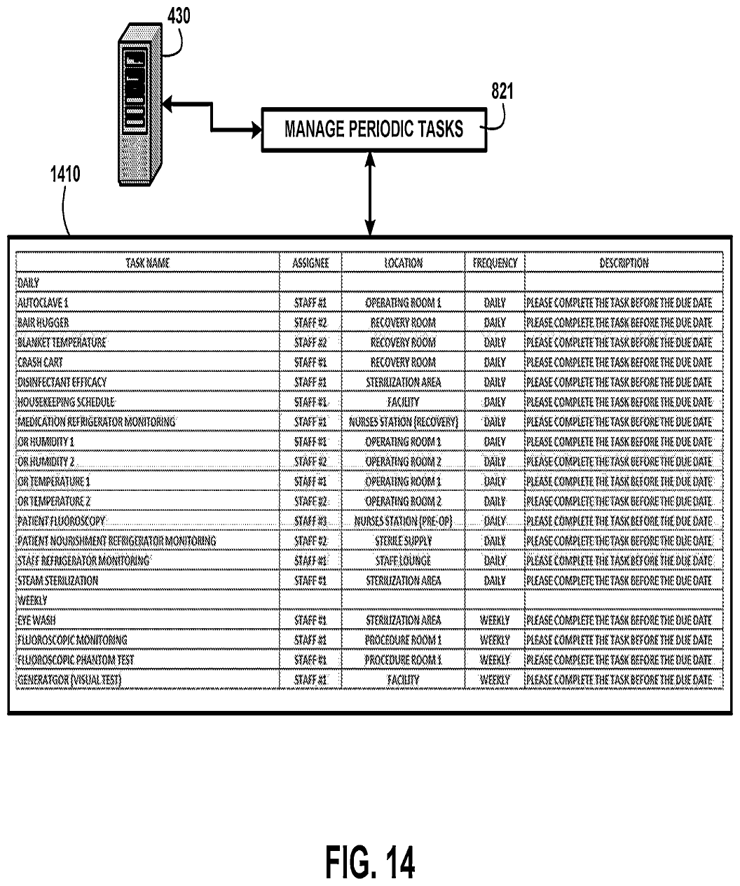

FIG. 14 shows for illustrative purposes only an example of a display to manage periodic tasks of one embodiment. FIG. 14 shows the registered company server 430 displaying on a computer screen not shown a manage periodic tasks 821 listing of tasks and assignees 1410. The listing includes a task name, the name of a task assignee, a location of the task, the frequency of the task and a description of the task. An example shown is a crash cart task assigned to staff #1. The crash cart is located in a recovery room and the task is to be completed daily. The manage periodic tasks 821 is used by a supervisor to review an assignee performance of task completions of one embodiment.

### A Process to Correct and Document Out of Compliance Conditions:

FIG. 15 shows for illustrative purposes only an example of a process to correct and document out of compliance conditions of one embodiment. FIG. 15 shows the registered company server 430 determining “out of normal” values and allowing a user to document corrections 1500. In this example the display shows an out of normal condition for humidity or 2 in operating room 2 1510. The humidity sensor reading is 69% above the normal operating room compliant environmental conditions for humidity in a range of 50 to 60%.

The out of normal condition display is shown automatically to a supervisor. The display includes an instruction wherein the supervisor can click on the gray bar to adjust the humidity 1520. When the supervisor clicks on the gray bar and adjusts the humidity to become “normal” and in compliance the corrective action is recorded on the registered company server 430. Clicking on the gray bar transmits a signal to the registered company server 430 to activate a remote digital actuator including a wireless digital actuator including a wireless digital dehumidifier device humidity level setting actuator for lowering the humidity in operating room 2 to bring the humidity into compliance of one embodiment.

The foregoing has described the principles, embodiments and modes of operation of the embodiments. However, the embodiments should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

1-20. (canceled)

21. A surgical center medical instrument regulating apparatus, comprising:
a remote server coupled via the internet to at least one medical instrument configured for use in a medical surgical environment, wherein the remote server includes a database with predetermined regulatory operating limits;
at least one digital sensor electronically connected to the at least one medical instrument and configured for sensing and transmitting operational conditions data to the remote server;
at least one processor coupled to the remote server and configured for analyzing and evaluating the operational conditions data against the regulatory operating standards to produce an evaluation of the operational conditions indicating if the at least one medical instrument is operating within predetermined regulatory limits;
wherein the remote server is configured to report the evaluation to a user for allowing the user to optionally manually change the operational conditions data; and
at least one digital controller electronically coupled to the at least one medical instrument and configured for receiving the evaluation and automatically controlling operating controls of the at least one medical instrument to adjust the operational conditions data to be within the predetermined regulatory standards.

22. The surgical center medical instrument regulating apparatus of claim 21, wherein the at least one digital sensor is configured for measuring a defibrillator battery charge to assure it is fully charged when needed.

23. The surgical center medical instrument regulating apparatus of claim 21, wherein the at least one digital sensor is configured for measuring at least one patient nourishment refrigerator temperature.

24. The surgical center medical instrument regulating apparatus of claim 21, wherein the at least one digital sensor is configured for measuring at least one medical instrument configured for maintaining surgical operating room environmental conditions.

25. The surgical center medical instrument regulating apparatus of claim 21, wherein the at least one digital controller is configured for adjusting heating and cooling medical instruments settings for operating within the predetermined compliance standards.

26. The surgical center medical instrument regulating apparatus of claim 21, wherein the at least one digital controller is configured to be operated remotely by the remote server.

27. The surgical center medical instrument regulating apparatus of claim 21, wherein the at least one processor coupled to the remote server is configured for determining the at least one medical instrument upper and lower operating conditions data compared to the upper and lower predetermined regulatory standards.

28. The surgical center medical instrument regulating apparatus of claim 21, wherein the remote server includes WIFI connectivity, and internet connectivity, electronically coupled to at least one processor, OCR devices, at least one database, printing devices, laser scanners, equipment interfaces, optical readers, and QR code and barcode readers, at least one digital sensor, at least one digital controller, and a medical instruments application.

29. The surgical center medical instrument regulating apparatus of claim 21, further comprising a medical instruments application installed on at least one digital sensor and at least one digital controller configured for uploading operating software updates.

30. An apparatus, comprising:
a remote server electronically coupled via the internet to at least one medical instrument configured for use during medical operating room procedures;
a database coupled to the remote server with predetermined compliance limits;
at least one digital sensor electronically coupled to the at least one medical instrument configured for transmitting sensor measured operational values to the remote server;
at least one digital processor coupled to the remote server configured for determining if the sensor measured operational values are within the predetermined compliance limits; and
at least one digital controller electronically coupled to the remote server configured for controlling settings of the at least one medical instrument to conform with operating room standards that are within the predetermined compliance limits.

31. The apparatus of claim 30, further comprising remote server equipment interfaces electronically coupled to the plurality of internet enabled digital sensors and plurality of internet enabled digital controllers configured for uploading data to the internet enabled digital devices including operating software updates.

32. The apparatus of claim 30, wherein at least one processor coupled to the remote server are configured for analyzing the at least one medical instrument upper and lower operational conditions in comparison to the upper and lower predetermined compliance limits.

33. The apparatus of claim 30, further comprising the remote server coupled OCR devices, laser scanners, equipment interfaces, optical readers, and QR code and barcode readers, a plurality of digital devices, internet enabled devices, and a medical instruments application.

34. The apparatus of claim 30, wherein the plurality of internet enabled digital sensors are configured for measuring at least one medical instrument including at least one defibrillator battery charge, patient nourishment refrigerator temperature, and at least surgical operating room environmental conditions including temperature, humidity and air flow rate.

35. The apparatus of claim 30, further comprising a medical instruments application coupled to the plurality of internet enabled digital sensors and internet enabled digital controllers configured for uploading data to internet enabled digital devices including medical instruments operating software updates.

36. A method, comprising:
providing a remote server electronically coupled via the internet to at least one medical instrument configured for use during medical operating room procedures;
providing a database coupled to the remote server with predetermined compliance limits;
providing at least one digital sensor electronically coupled to the at least one medical instrument configured for transmitting sensor measured operational values to the remote server;
providing at least one digital processor coupled to the remote server configured for determining if the sensor measured operational values are within the predetermined compliance limits; and
providing at least one digital controller electronically coupled to the remote server configured for controlling settings of the at least one medical instrument to conform with operating room standards that are within the predetermined compliance limits.

37. The method of claim 36, wherein adjusting the at least one medical instrument operation settings including surgical operating room environmental conditions including temperature, humidity and air flow rate within the predetermined compliance limits.

38. The method of claim 36, wherein measuring at least one medical instrument operational values includes a defibrillator battery charge.

39. The method of claim 36, wherein measuring at least one medical instrument operational values includes a patient nourishment refrigerator temperature.

40. The method of claim 36, wherein downloading predetermined compliance limits for at least one medical instrument operations using a remote server includes updating the predetermined compliance limits on a predetermined basis.
